(19) United States
(12) Patent Application Publication
(10) Pub. No.: US 2012/0322951 A1
(43) Pub. Date: Dec. 20, 2012

(54) CLEAR BLENDS OF ALIPHATIC-AROMATIC POLYESTERS AND ALIPHATIC POLYESTERS

(75) Inventors: Wesley Raymond Hale, Kingsport, TN (US); Gary Michael Stack, Kingsport, TN (US)

(73) Assignee: Eastman Chemical Company, Kingsport, TN (US)

(21) Appl. No.: 13/162,890

(22) Filed: Jun. 17, 2011

(51) Int. Cl. C08L 67/03

(52) U.S. Cl. 525/450

(57) ABSTRACT

This invention relates to a miscible polymer blend comprising: (a) an aliphatic-aromatic polyester comprising 70 to 100 mole % terephthalic acid residues; and 75 to 100 mole % of 2,2,4,4-tetramethyl-1,3-cyclobutanediol residues; and (b) at least one aliphatic polyester comprising cyclohexanedicarboxylic acid residues; and 75 to 100 mole % cyclohexanedimethanol residues.

### BACKGROUND OF THE INVENTION

Clear blends of two polymers are rare. Even rarer, are clear blends of aromatic copolyesters (PTTMCD) and aliphatic copolyesters (PCCD) due to the unfavorable interactions that are common between saturated (free electron count is low) and unsaturated polymeric species (free electron count is high).

There is a need in the art for a polymer blend that is useful in molding plastics, fibers, and films and which also have excellent clarity, good heat resistance and good toughness.

### BRIEF SUMMARY OF THE INVENTION

This invention provides blends of polyesters comprising units of terephthalic acid, 2,2,4,4-tetramethy-1,3-cyclobutanediol (PTTMCD) with polyesters comprising units of 1,4 cyclohexanedicarboxylic acid and 1,4 cyclohexanedimethanol (PCCD) having excellent clarity, good heat resistance and good toughness.

In one aspect, the polymer blend of the invention comprises:

(I) 5 to 95 weight % of at least one aliphatic-aromatic polyester which comprises:
(a) a dicarboxylic acid component comprising:
   (i) 70 to 100 mole % of terephthalic acid residues;
   (ii) 0 to 30 mole % of the residues of at least one aromatic dicarboxylic acid having up to 20 carbon atoms; and
   (iii) 0 to 10 mole % of the residues of at least one aliphatic dicarboxylic acid having up to 16 carbon atoms; and
(b) a diol component comprising:
   (i) 75 to 100 mole % of 2,2,4,4-tetramethyl-1,3-cyclobutanediol residues; and
   (ii) 0 to 25 mole % of the residues of aliphatic or aromatic diols having up to 20 carbon atoms;
      wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 75 to 100 mole % of 2,2,4,4-tetramethyl-1,3-cyclobutanediol residues; and
      (ii) 0 to 25 mole % of 25 mole percent of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 1.0 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 90 to 100 mole % of 2,2,4,4-tetramethyl-1,3-cyclobutanediol residues; and
      (ii) 0 to 10 mole % percent of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.85 dL/g as determined in 60/40 (wt/wt) phenol/tetrachloroethane at a concentration of 0.25 g/50 ml at 25° C.; and wherein the aliphatic-aromatic polyester has a Tg from 130 to 190° C. In one embodiment, the Tg of the aliphatic-aromatic polyester is from 165 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 75 to 100 mole % of 2,2,4,4-tetramethyl-1,3-cyclobutanediol residues; and
      (ii) 0 to 25 mole % percent of the residues of aliphatic or aromatic diols having up to 20 carbon atoms;
   wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.; and, wherein the aliphatic polyester has a glass transition temperature of from greater than 60° C. to 155° C. In one embodiment, the Tg of the aliphatic polyester is from 110 to 140° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 20 carbon atoms; and
   (b) a diol component comprising:
      (i) 75 to 100 mole % of 2,2,4,4-tetramethyl-1,3-cyclobutanediol residues; and
      (ii) 0 to 25 mole % of the residues of aliphatic or aromatic diols having up to 20 carbon atoms;
   wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and wherein the inherent viscosity of the aliphatic-aromatic polyester is from 0.35 to .65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 99 mole % of terephthalic acid residues;
      (ii) 1 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 75 to less than 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole %; and, the total mole % of the diol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.75 dL/g as determined in 60/40 (wt/wt) phenol/tetrachloroethane at a concentration of 0.25 g/50 ml at 25° C.; and, wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 99 mole % of terephthalic acid residues;
      (ii) 1 to 30 mole % of the residues of at least one aromatic dicarboxylic acid having up to 20 carbon atoms; and
      (iii) 0 to 10 mole % of the residues of at least one aliphatic dicarboxylic acid having up to 20 carbon atoms; and
   (b) a diol component comprising:
      (i) 75 to less than 99 mole % of 2,2,4,4-tetramethyl-1,3-cyclobutanediol residues; and
      (ii) 1 to 25 mole % of the residues of aliphatic or aromatic diols having up to 20 carbon atoms;
   wherein the total mole % of the dicarboxylic acid component is 100 mole %, and the total mole % of the diol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and, wherein the inherent viscosity of the aliphatic-aromatic polyester is from 0.35 to 0.75 dL/g as determined in 60/40 (wt/wt) phenol/tetrachloroethane at a concentration of 0.25 g/50 ml at 25° C.; ; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 75 to 98 mole % of terephthalic acid residues;
      (ii) 1 to 25 mole % of the residues of at least one aromatic dicarboxylic acid having up to 20 carbon atoms; and
      (iii) 1 to 25 mole % of the residues of at least one aliphatic dicarboxylic acid having up to 20 carbon atoms; and
   (b) a diol component comprising:
      (i) 75 to 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 75 to 100 mole % of terephthalic acid residues;
      (ii) 0 to 25 mole % of the residues of at least one aromatic dicarboxylic acid having up to 20 carbon atoms; and
      (iii) 0 to 25 mole % of the residues of at least one aliphatic dicarboxylic acid having up to 20 carbon atoms; and
   (b) a diol component comprising:
      (i) 75 to 99 mole % of 2,2,4,4-tetramethyl-1,3-cyclobutanediol residues; and
      (ii) 1 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 75 to 98 mole % of terephthalic acid residues;
      (ii) 1 to 25 mole % of the residues of at least one aromatic dicarboxylic acid having up to 20 carbon atoms; and
      (iii) 1 to 25 mole % of the residues of at least one aliphatic dicarboxylic acid having up to 20 carbon atoms; and
   (b) a diol component comprising:
      (i) 75 to 99 mole % of 2,2,4,4-tetramethyl-1,3-cyclobutanediol residues; and
      (ii) 1 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 20 carbon atoms; and
   (b) a diol component comprising:
      (i) 75 to 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
(III) Titanium atoms and phosphorus atoms;
   wherein the total mole % of the dicarboxylic acid component is 100 mole %, and the total mole % of the diol component is 100 mole %; and wherein the inherent viscosity of the aliphatic-aromatic polyester is from 0.35 to .65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C. In one embodiment the inherent viscosity of the aliphatic-aromatic polyester is from 0.40 to 0.85 dL/g as determined in 60/40 (wt/wt) phenol/ tetrachloroethane at a concentration of 0.25 g/50 ml at 25° C.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and,
   (b) a glycol component comprising:
      (i) about 90 to about 100 mole % 2,2,4,4-tetramethyl-1,3-cyclobutanediol residues; and,
      (ii) about 0 to about 10 mole % of other residues; and,
      (iii) ethylene glycol residues; and,
      (iv) less than about 2 mole % of a modifying glycol having from 3 to 16 carbon atoms;
   (c) optionally, residues of at least one branching agent;
   (d) wherein the total mole % of the dicarboxylic acid component is 100 mole %, and the total mole % of the diol component is 100 mole %; and titanium atoms and phosphorus atoms;
      wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and wherein the inherent viscosity of the aliphatic-aromatic polyester is from 0.40 to 0.74 dL/g as determined in 60/40 (wt/wt) phenol/ tetrachloroethane at a concentration of 0.25 g/50 ml at 25° C.
wherein the total mole % of the glycol component is equal to 100 mole %;
wherein the inherent viscosity of the aliphatic polyester is from 0.35 to 1.2 dL/g as determined in 60/40 (wt/wt) phenol/ tetrachloroethane at a concentration of 0.25 g/50 ml at 25° C.; and
wherein the aliphatic polyester has a glass transition temperature of from greater than 60° C. to 155° C.

In one aspect of the invention, the aliphatic polyester comprises:
(A) a dicarboxylic acid component comprising:
   (i) about 70 to about 100 mole % of cyclohexanedicarboxylic acid residues;
   (ii) about 0 to about 30 mole % of aliphatic dicarboxylic acid residues, other than cyclohexanedicarboxylic acid residues, having up to 20 carbon atoms; and
   (iii) 0 to 10 mole % of aromatic dicarboxylic acid residues having up to 20 carbon atoms; and
(B) a glycol component comprising:
   (i) 50 to 90 mole % 2,2,4,4-tetramethyl-1,3-cyclobutanediol residues; and
   (ii) 10 to 50 mole % cyclohexanedimethanol residues; wherein the total mole % of the dicarboxylic acid component is equal to 100 mole %;
wherein the total mole % of the glycol component is equal to 100 mole %;
wherein the inherent viscosity of the aliphatic polyester is from 0.5 to 1.2 dL/g as determined in 60/40 (wt/wt) phenol/ tetrachloroethane at a concentration of 0.25 g/50 ml at 25° C.; and
wherein the aliphatic polyester has a glass transition temperature of from greater than 60° C. to 155° C.

In one aspect, the aliphatic-aromatic polyesters useful in the invention and/or the aliphatic polyesters useful in the invention contain ethylene glycol residues.

In one aspect, the aliphatic-aromatic polyesters useful in the invention and/or the aliphatic polyesters useful in the invention contain no ethylene glycol residues.

In one aspect, the the aliphatic-aromatic polyesters useful in the invention and/or the aliphatic polyesters useful in the invention contain no branching agent, or alternatively, at least one branching agent is added either prior to or during polymerization of the polyester.

In one aspect, the aliphatic-aromatic polyesters useful in the invention and/or the aliphatic polyesters useful in the invention contain at least one branching agent without regard to the method or sequence in which it is added.

These polymer blends result in a material that is both clear and tough.

### DETAILED DESCRIPTION

Unless otherwise indicated, all numbers expressing quantities of ingredients, properties such as molecular weight, reaction conditions, and so forth used in the specification and claims are to be understood as being modified in all instances by the term “about.” Unless indicated to the contrary, the numerical parameters set forth in the following specification and attached claims are approximations that may vary depending upon the desired properties sought to be obtained by the present invention. At the very least, each numerical parameter should be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to 0₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that polymer blends of the invention can have a unique combination of two or more physical properties such as moderate or high impact strengths, high glass transition temperatures, chemical resistance, toughness, low ductile-to-brittle transition temperatures, good color and clarity, low densities, and long crystallization half-times. In some of the embodiments of the invention, the polymer blends have a unique combination of the properties of good impact strength, heat resistance, clarity, density and/or the combination of the properties of good impact strength, heat resistance, and clarity and/or the combination of two or more of the described properties.

In one embodiment, the processes of making the polyesters useful in the blends of the invention can comprise a batch or continuous process.

### DETAILED DESCRIPTION

This invention relates to a polymer blend comprising:
(A) 5 to 95 weight % of at least one aliphatic-aromatic copolyester (AAPE) which comprises:
   (i) a dicarboxylic acid component comprising:
      (a) 70 to 100 mole % of terephthalic acid residues; and
      (b) 0 to 30 mole % of one or more dicarboxylic acid residues; and,
   (ii) a glycol component comprising:
      (a) 75 to 100 mole % of 2,2,4,4-tetramethyl-1,3-cyclobutanediol residues; and,
      (b) 0 to 25 mole % of one or more additional glycol residues;
         wherein the total mole % of the dicarboxylic acid component is 100 mole % and wherein the total mole % of the glycol component is 100 mole %; and,
(B) 5 to 95 weight % of at least one aliphatic polyester (APE) which comprises:
   (i) a dicarboxylic acid component comprising cyclohexanedicarboxylic acid residues; and,
   (ii) a glycol component comprising:
      (a) 75 to 100 mole % cyclohexanedimethanol residues; and,
      (b) 0 to 25 mole % of one or more additional glycol or polymeric glycol residues; and,
      (c) 0 to 5 mole % of one or more branching agents; wherein the total mole % of the dicarboxylic acid component is 100 mole % and wherein the total mole % of the glycol component is 100 mole %.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, in the case of AAPE polyesters, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. Alternatively, in the case of aliphatic polyesters, the difunctional carboxylic acid may be a hydroxy carboxylic acid such as, for example, p-hydroxybenzoic acid, and the difunctional hydroxyl compound may be an aliphatic nucleus bearing 2 hydroxyl substituents such as, for example, 1,3-cyclohexanediol or 1,4-cyclohexanediol. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The APPE polyesters and/or the aliphatic polyesters useful in the present invention typically can be prepared from dicarboxylic acids and diols which react in substantially equal proportions and are incorporated into the polyester polymer as their corresponding residues. The APPE polyesters and/or the aliphatic polyesters useful in the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 80 mole % 2,2,4,4-tetramethyl-1,3-cyclobutanediol, based on the total diol residues, means the polyester contains 80 mole % 2,2,4,4-tetramethyl-1,3-cyclobutanediol residues out of a total of 100 mole % diol residues. Thus, there are 80 moles of 2,2,4,4-tetramethyl-1,3-cyclobutanediol (TMCD) residues among every 100 moles of diol residues.

In addition to the diols set forth above, the AAPE polyesters and/or the aliphatic polyesters useful in the polyester blends of the invention may comprise 1,3-propanediol, 1,4-butanediol, and mixtures thereof. It is contemplated that compositions of the invention made from 1,3-propanediol, 1,4-butanediol, and mixtures thereof can possess at least one of the Tg ranges described herein, at least one of the inherent viscosity ranges described herein, and/or at least one of the glycol or diacid ranges described herein.

This invention relates to a polymer blend comprising:
(A) 5 to 95 weight % of at least one aliphatic-aromatic copolyester (AAPE) which comprises:
   (i) a dicarboxylic acid component comprising:
      (a) 70 to 100 mole % of terephthalic acid residues; and
      (b) 0 to 30 mole % of one or more dicarboxylic acid residues; and,
   (ii) a glycol component comprising:
      (a) 75 to 100 mole % of 2,2,4,4-tetramethyl-1,3-cyclobutanediol residues; and,
      (b) 0 to 25 mole % of one or more additional glycol residues;
         wherein the total mole % of the dicarboxylic acid component is 100 mole % and wherein the total mole % of the glycol component is 100 mole %; and,
(B) 5 to 95 weight % of at least one aliphatic polyester (APE) which comprises:
   (i) a dicarboxylic acid component comprising cyclohexanedicarboxylic acid residues; and,
   (ii) a glycol component comprising:
      (d) 75 to 100 mole % cyclohexanedimethanol residues; and,
      (e) 0 to 25 mole % of one or more additional glycol or polymeric glycol residues; and,
      (f) 0 to 5 mole % of one or more branching agents;
         wherein the total mole % of the dicarboxylic acid component is 100 mole % and wherein the total mole % of the glycol component is 100 mole %.

This invention also relates to a polymer blend wherein said aliphatic-aromatic polyester (AAPE) comprises about 70 to about 100 mole percent, based on the total moles of diacid residues, of the residues of terephthalic acid, isophthalic acid, or combinations thereof; and about 75 to about 100 mole percent of the residues of 2,2,4,4-tetramethyl-1,3-cyclobutanediol, and 0 to about 25 mole percent of the residues of aliphatic or aromatic diols having up to 20 carbon atoms. Examples include, but are not limited to, 1,4-cyclohexanedimethanol, neopentyl glycol, diethylene glycol, ethylene glycol, 1,2-propanediol, 1,3-propanediol, 1,4-butanediol, 1,5-pentanediol, 1,6-hexanediol, 1,8-octanediol, 2,2,4-trimethyl-1,3-pentanediol, 1,3-cyclohexanedimethanol, bisphenol A, polyalkylene glycol, or combinations thereof.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 75 to 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 75 to 100 mole % of 2,2,4,4-tetramethyl-1,3-cyclobutanediol residues; and
      (ii) 0 to 25 mole % of 25 mole percent of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 1.0 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 90 to 100 mole % of 2,2,4,4-tetramethyl-1,3-cyclobutanediol residues; and
      (ii) 0 to 10 mole % percent of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.85 dL/g as determined in 60/40 (wt/wt) phenol/tetrachloroethane at a concentration of 0.25 g/50 ml at 25° C.; and wherein the aliphatic-aromatic polyester has a Tg from 130 to 190° C. In one embodiment, the Tg of the aliphatic-aromatic polyester is from 165 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 75 to 100 mole % of 2,2,4,4-tetramethyl-1,3-cyclobutanediol residues; and
      (ii) 0 to 25 mole % percent of the residues of aliphatic or aromatic diols having up to 20 carbon atoms;
   wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.; and,
      wherein the aliphatic polyester has a glass transition temperature of from greater than 60° C. to 155° C. In one embodiment, the Tg of the aliphatic polyester is from 110 to 140° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 20 carbon atoms; and
   (b) a diol component comprising:
      (i) 75 to 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 99 mole % of terephthalic acid residues;
      (ii) 1 to 30 mole % of the residues of at least one aromatic dicarboxylic acid having up to 20 carbon atoms; and
      (iii) 0 to 10 mole % of the residues of at least one aliphatic dicarboxylic acid having up to 16 carbon atoms; and
   (b) a diol component comprising:
      (i) 75 to less than 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole %; and, the total mole % of the diol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and wherein the inherent viscosity of the aliphatic-aromatic polyester is from 0.35 to 0.75 dL/g as determined in 60/40 (wt/wt) phenol/tetrachloroethane at a concentration of 0.25 g/50 ml at 25° C.; and,
wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 99 mole % of terephthalic acid residues;
      (ii) 1 to 30 mole % of the residues of at least one aromatic dicarboxylic acid having up to 20 carbon atoms; and
      (iii) 0 to 10 mole % of the residues of at least one aliphatic dicarboxylic acid having up to 20 carbon atoms; and
   (b) a diol component comprising:
      (i) 75 to less than 99 mole % of 2,2,4,4-tetramethyl-1,3-cyclobutanediol residues; and
      (ii) 1 to 25 mole % of the residues of aliphatic or aromatic diols having up to 20 carbon atoms;
         wherein the total mole % of the dicarboxylic acid component is 100 mole %, and the total mole % of the diol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
wherein the total mole % of the dicarboxylic acid component is 100 mole %, and the total mole % of the diol component is 100 mole %; and,
wherein the inherent viscosity of the aliphatic-aromatic polyester is from 0.35 to 0.75 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 75 to 98 mole % of terephthalic acid residues;
      (ii) 1 to 25 mole % of the residues of at least one aromatic dicarboxylic acid having up to 20 carbon atoms; and
      (iii) 1 to 25 mole % of the residues of at least one aliphatic dicarboxylic acid having up to 20 carbon atoms; and
   (b) a diol component comprising:
      (i) 75 to 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 75 to 100 mole % of terephthalic acid residues;
      (ii) 0 to 25 mole % of the residues of at least one aromatic dicarboxylic acid having up to 20 carbon atoms; and
      (iii) 0 to 25 mole % of the residues of at least one aliphatic dicarboxylic acid having up to 20 carbon atoms; and
   (b) a diol component comprising:
      (i) 75 to 99 mole % of 2,2,4,4-tetramethyl-1,3-cyclobutanediol residues; and
      (ii) 1 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 75 to 98 mole % of terephthalic acid residues;
      (ii) 1 to 25 mole % of the residues of at least one aromatic dicarboxylic acid having up to 20 carbon atoms; and
      (iii) 1 to 25 mole % of the residues of at least one aliphatic dicarboxylic acid having up to 20 carbon atoms; and
   (b) a diol component comprising:
      (i) 75 to 99 mole % of 2,2,4,4-tetramethyl-1,3-cyclobutanediol residues; and
      (ii) 1 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
      wherein the total mole % of the dicarboxylic acid component is 100 mole %, and the total mole % of the diol component is 100 mole %; and wherein the inherent viscosity of the aliphatic-aromatic polyester is from 0.35 to 0.65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C.

In one aspect, the polymer blend of the invention comprises:
(I) 5 to 95 weight % of at least one aliphatic-aromatic polyester which comprises:
   (a) a dicarboxylic acid component comprising:
      (i) 70 to 100 mole % of terephthalic acid residues;
      (ii) 0 to 30 mole % of the residues of at least one aromatic dicarboxylic acid having up to 20 carbon atoms; and
      (iii) 0 to 10 mole % of the residues of at least one aliphatic dicarboxylic acid having up to 20 carbon atoms; and
   (b) a diol component comprising:
      (i) 75 to 100 mole % of 2,2,4,4-tetramethyl-1,3-cyclobutanediol residues; and
      (ii) 0 to 25 mole % of the residues of aliphatic or aromatic diols having up to 20 carbon atoms;
         wherein the total mole % of the dicarboxylic acid component is 100 mole % and wherein the total mole % of the glycol component is 100 mole %; and,
(II) 5 to 95 weight % of at least one aliphatic polyester which comprises:
   (a) a dicarboxylic acid component comprising cyclohexanedicarboxylic acid residues; and
   (b) a glycol component comprising cyclohexanedimethanol residues;
(III) Titanium atoms and phosphorus atoms;
   wherein the total mole % of the dicarboxylic acid component is 100 mole %, and the total mole % of the diol component is 100 mole %; and wherein the inherent viscosity of the aliphatic-aromatic polyester is from 0.35 to .65 dL/g as determined in 60/40 (wt/wt) phenol/tetrachloroethane at a concentration of 0.25 g/50 ml at 25° C.; and wherein the aliphatic-aromatic polyester has a Tg from 120 to 190° C. In one embodiment, the Tg of the aliphatic-aromatic polyester is from 160 to 190° C. In one embodiment the inherent viscosity of the aliphatic-aromatic polyester is from 0.40 to 0.85 dL/g as determined in 60/40 (wt/wt) phenol/ tetrachloroethane at a concentration of 0.25 g/50 ml at 25° C.

In one aspect, the polymer blend of the invention comprises:
(I) 5 to 95 weight % of at least one aliphatic-aromatic polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and,
   (b) a glycol component comprising:
      (i) about 90 to about 100 mole % 2,2,4,4-tetramethyl-1,3-cyclobutanediol residues; and,
      (ii) about 0 to about 10 mole % of other residues; and,
      (iii) ethylene glycol residues; and,
      (iv) less than about 2 mole % of a modifying glycol having from 3 to 16 carbon atoms;
   (e) optionally, residues of at least one branching agent;
   (f) wherein the total mole % of the dicarboxylic acid component is 100 mole %, and the total mole % of the diol component is 100 mole %; and titanium atoms and phosphorus atoms; wherein the total mole % of the dicarboxylic acid component is 100 mole %, and the total mole % of the diol component is 100 mole %; and
(II) 5 to 95 weight % of at least one aliphatic polyester which comprises:
   (a) a dicarboxylic acid component comprising cyclohexanedicarboxylic acid residues; and
   (b) a glycol;
wherein the total mole % of the dicarboxylic acid component is 100 mole %, and the total mole % of the diol component is 100 mole %; and
wherein the inherent viscosity of the aliphatic-aromatic polyester is from 0.40 to 0.74 dL/g as determined in 60/40 (wt/wt) phenol/ tetrachloroethane at a concentration of 0.25 g/50 ml at 25° C.
wherein the total mole % of the glycol component is equal to 100 mole %;
wherein the inherent viscosity of the aliphatic polyester is from 0.35 to 1.2 dL/g as determined in 60/40 (wt/wt) phenol/ tetrachloroethane at a concentration of 0.25 g/50 ml at 25° C.; and
wherein the aliphatic polyester has a glass transition temperature of from greater than 60° C. to 155° C.

In one aspect of the invention, the aliphatic polyester comprises:
(A) a dicarboxylic acid component comprising:
   (i) about 70 to about 100 mole % of cyclohexanedicarboxylic acid residues;
   (ii) about 0 to about 30 mole % of aliphatic dicarboxylic acid residues, other than cyclohexanedicarboxylic acid residues, having up to 20 carbon atoms; and
   (iii) 0 to 10 mole % of aromatic dicarboxylic acid residues having up to 20 carbon atoms; and
(B) a glycol component comprising:
   (i) 50 to 90 mole % 2,2,4,4-tetramethyl-1,3-cyclobutanediol residues; and
   (ii) 10 to 50 mole % cyclohexanedimethanol residues;
wherein the total mole % of the dicarboxylic acid component is equal to 100 mole %;
wherein the total mole % of the glycol component is equal to 100 mole %;
wherein the inherent viscosity of the aliphatic polyester is from 0.5 to 1.2 dL/g as determined in 60/40 (wt/wt) phenol/ tetrachloroethane at a concentration of 0.25 g/50 ml at 25° C.; and
wherein the aliphatic polyester has a glass transition temperature of from greater than 60° C. to 155° C.

In one aspect, the aliphatic-aromatic polyesters useful in the invention and/or the aliphatic polyesters useful in the invention can comprise at least one phosphate ester described herein.

In one aspect, the aliphatic-aromatic polyesters useful in the invention and/or the aliphatic polyesters useful in the invention can comprise phosphorus atoms.

In one aspect, the aliphatic-aromatic polyesters useful in the invention and/or the aliphatic polyesters useful in the invention can comprise tin atoms.

In one aspect, the aliphatic-aromatic polyesters useful in the invention and/or the aliphatic polyesters useful in the invention contain ethylene glycol residues.

In one aspect, the aliphatic-aromatic polyesters useful in the invention and/or the aliphatic polyesters useful in the invention contain no ethylene glycol residues.

In one aspect, the aliphatic-aromatic polyesters useful in the invention and/or the aliphatic polyesters useful in the invention contain no branching agent, or alternatively, at least one branching agent is added either prior to or during polymerization of the polyester.

In one aspect, the aliphatic-aromatic polyesters useful in the invention and/or the aliphatic polyesters useful in the invention contain at least one branching agent without regard to the method or sequence in which it is added.

In one aspect, any of the aliphatic-aromatic polyesters may comprise at least one tin compound and, optionally, at least one catalyst chosen from titanium, gallium, zinc, antimony, cobalt, manganese, magnesium, germanium, lithium, aluminum compounds and an aluminum compound with lithium hydroxide or sodium hydroxide.

In one embodiment, any of the aliphatic-aromatic polyesters of making the polyesters useful in the invention may be prepared using at least one tin compound and at least one catalyst chosen from titanium compounds as catalysts.

For embodiments of the invention, the AAPE polyesters and/or the aliphatic polyesters useful in the polymer blends of the invention may exhibit at least one of the following inherent viscosities as determined in 60/40 (wt/wt) phenol/ tetrachloroethane at a concentration of 0.25 g/50 ml at 25° C.: 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; 0.42 to 1.2 dL/g; 0.42 to 1.1 dL/g; 0.42 to 1 dL/g; 0.42 to less than 1 dL/g; 0.42 to 0.98 dL/g; 0.42 to 0.95 dL/g; 0.42 to 0.90 dL/g; 0.42 to 0.85 dL/g; 0.42 to 0.80 dL/g; 0.42 to 0.75 dL/g; 0.42 to less than 0.75 dL/g; 0.42 to 0.72 dL/g; 0.42 to 0.70 dL/g; 0.42 to less than 0.70 dL/g; 0.42 to 0.68 dL/g; 0.42 to less than 0.68 dL/g; and 0.42 to 0.65 dL/g.

For embodiments of the invention, the AAPE polyesters and/or the aliphatic polyesters useful in the polymer blends of the invention may exhibit at least one of the following inherent viscosities as determined in 60/40 (wt/wt) phenol/ tetrachloroethane at a concentration of 0.25 g/50 ml at 25° C.: 0.35 to 1.2 dL/g; 0.35 to 1.1 dL/g; 0.35 to 1 dL/g; 0.35 to 0.98 dL/g; 0.35 to 0.95 dL/g; 0.35 to 0.90 dL/g0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g0.35 to less than 0.70 dL/g; 0.35 to 0.68 dL/g; 0.35 to less than 0.68 dL/g; 0.35 to 0.65 dL/g; 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.67 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.60 to 0.64 dL/g; 0.61 to 0.68 dL/g; 0.64 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g.

In one embodiment, terephthalic acid may be used as a starting material. In another embodiment, dimethyl terephthalate may be used as a starting material. In yet another embodiment, mixtures of terephthalic acid and dimethyl terephthalate may be used as a starting material and/or as an intermediate material.

The cyclohexanedimethanol of the aliphatic copolyester may be cis, trans, or a mixture thereof, for example, a cis/trans ratio of 60:40 to 40:60 or a cis/trans ratio of 70:30 to 30:70. In another embodiment, the trans-cyclohexanedimethanol can be present in an amount of 0 to 30 mole % and the cis-cyclohexanedimethanol can be present in an amount of 0 to 30 mole % wherein the total percentages of cis-cyclohexanedimethanol and trans-cyclohexanedimethanol is equal to 0 to 25 mole %. Any isomers of cyclohexanedimethanol or mixtures thereof may be present in the glycol component of this invention. In one embodiment, the AAPE polyesters and/or aliphatic useful in the invention comprise 1,4-cyclohexanedimethanol.

Modifying glycols useful in the AAPE polyesters and/or aliphatic polyesters useful in the polymer blends of the invention refer to diols other than 2,2,4,4-tetramethyl-1,3-cyclobutanediol and cyclohexanedimethanol and can contain 2 to 16 carbon atoms. Examples of suitable modifying glycols include, but are not limited to, ethylene glycol residues, 1,2-propanediol, 1,3-propanediol, neopentyl glycol, 1,4-butanediol, 1,5-pentanediol, 1,6-hexanediol, p-xylene glycol, polytetramethylene glycol, polyethylene glycol, and/or mixtures thereof. In one embodiment, the modifying glycol is ethylene glycol. In another embodiment, the modifying glycols include, but are not limited to, at least one of 1,3-propanediol and 1,4-butanediol. In another embodiment, ethylene glycol residues are excluded as a modifying diol. In another embodiment, 1,3-propanediol and 1,4-butanediol are excluded as modifying diols. In another embodiment, 2,2-dimethyl-1,3-propanediol is excluded as a modifying diol.

The AAPE polyesters and/or aliphatic polyesters useful in the polymer blends of the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the AAPE polyester and/or aliphatic polyester. The AAPE polyester(s) and/or aliphatic polyester useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The AAPE polyesters and/or aliphatic polyesters useful in the polymer blends of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

The glass transition temperature (Tg) of the AAPE polyesters and/or aliphatic polyesters useful in the polymer blends of the invention was determined using a TA DSC 2920 and clarity was determined by visual observation. In one embodiment, certain AAPE polyesters as well as the polymer blends useful in this invention can be visually clear. The term “visually clear” is defined herein as an appreciable absence of cloudiness, haziness, and/or muddiness, when inspected visually. In another embodiment, when the polyesters are blended with polycarbonate, including but not limited to, bisphenol A polycarbonates, the blends can be visually clear.

Notched Izod impact strength, as described in ASTM D256, is a common method of measuring toughness.

In one aspect, the phosphorus compounds useful in AAPE polyesters and/or the aliphatic polyesters useful in the polymer blends of the invention comprise phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl.

In one aspect, the phosphorus compounds useful in AAPE polyesters and/or the aliphatic polyesters useful in the polymer blends of the invention can be chosen from at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed alkyl aryl phosphites, reaction products thereof, and mixtures thereof.

When phosphorus is added to the polyesters and/or polyester blends and/or process of making the polyesters useful in the invention, it is added in the form of a phosphorus compound, for example, at least one phosphate ester(s). The amount of phosphorus compound(s), (for example, at least one phosphate ester), is added to the AAPE polyesters and/or aliphatic polyesters useful in the invention and/or polyester blends of the invention and/or processes of the invention can be measured in the form of phosphorus atoms present in the final polyester, for example, by weight measured in ppm.

In one embodiment, the polymer blends of the invention can comprise 5 to 90 weight % of said at least one aliphatic-aromatic polyester and 10 to 95 weight % of said at least one aliphatic polyester, wherein the total weight % of the aliphatic-aromatic polyester and the aliphatic polyester equals 100weight %. In one embodiment, the polymer blends of the invention can comprise 5 to 85 weight % of said at least one aliphatic-aromatic polyester and 15 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 75 weight % of said at least one aliphatic-aromatic polyester and 25 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 70 weight % of said at least one aliphatic-aromatic polyester and 30 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 65 weight % of said at least one aliphatic-aromatic polyester and 35 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 55 weight % of said at least one aliphatic-aromatic polyester and 45 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 50 weight % of said at least one aliphatic-aromatic polyester and 50 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 45 weight % of said at least one aliphatic-aromatic polyester and 55 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 40 weight % of said at least one aliphatic-aromatic polyester and 60 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 35 weight % of said at least one aliphatic-aromatic polyester and 65 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 30 weight % of said at least one aliphatic-aromatic polyester and 70 to 95 weight % of said at least one aliphatic polyester, wherein the total weight % of the aliphatic-aromatic polyester and the aliphatic polyester equals 100 weight %. In one embodiment, the polymer blends of the invention can comprise 5 to 25 weight % of said at least one aliphatic-aromatic polyester and 75 to 95 weight % of said at least one aliphatic polyester, wherein the total weight % of the aliphatic-aromatic polyester and the aliphatic polyester equals 100 weight %.

In one embodiment, the polymer blends of the invention can comprise 10 to 90 weight % of said at least one aliphatic-aromatic polyester and 10 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 85 weight % of said at least one aliphatic-aromatic polyester and 15 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 75 weight % of said at least one aliphatic-aromatic polyester and 25 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 70 weight % of said at least one aliphatic-aromatic polyester and 30 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 65 weight % of said at least one aliphatic-aromatic polyester and 35 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 55 weight % of said at least one aliphatic-aromatic polyester and 45 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 50 weight % of said at least one aliphatic-aromatic polyester and 50 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 45 weight % of said at least one aliphatic-aromatic polyester and 55 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 40 weight % of said at least one aliphatic-aromatic polyester and 60 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 35 weight % of said at least one aliphatic-aromatic polyester and 65 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 30 weight % of said at least one aliphatic-aromatic polyester and 70 to 90 weight % of said at least one aliphatic polyester, wherein the total weight % of the aliphatic-aromatic polyester and the aliphatic polyester equals 100 weight %. In one embodiment, the polymer blends of the invention can comprise 10 to 25 weight % of said at least one aliphatic-aromatic polyester and 75 to 90 weight % of said at least one aliphatic polyester, wherein the total weight % of the aliphatic-aromatic polyester and the aliphatic polyester equals 100 weight %.

In one embodiment, the polymer blends of the invention can comprise 15 to 90 weight % of said at least one aliphatic-aromatic polyester and 10 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 85 weight % of said at least one aliphatic-aromatic polyester and 15 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 75 weight % of said at least one aliphatic-aromatic polyester and 25 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 70 weight % of said at least one aliphatic-aromatic polyester and 30 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 65 weight % of said at least one aliphatic-aromatic polyester and 35 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 55 weight % of said at least one aliphatic-aromatic polyester and 45 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 50 weight % of said at least one aliphatic-aromatic polyester and 50 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 45 weight % of said at least one aliphatic-aromatic polyester and 55 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 40 weight % of said at least one aliphatic-aromatic polyester and 60 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 35 weight % of said at least one aliphatic-aromatic polyester and 65 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 30 weight % of said at least one aliphatic-aromatic polyester and 70 to 85 weight % of said at least one aliphatic polyester, wherein the total weight % of the aliphatic-aromatic polyester and the aliphatic polyester equals 100 weight %. In one embodiment, the polymer blends of the invention can comprise 15 to 25 weight % of said at least one aliphatic-aromatic polyester and 75 to 85 weight % of said at least one aliphatic polyester, wherein the total weight % of the aliphatic-aromatic polyester and the aliphatic polyester equals 100 weight %.

In one embodiment, the polymer blends of the invention can comprise 20 to 90 weight % of said at least one aliphatic-aromatic polyester and 10 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 85 weight % of said at least one aliphatic-aromatic polyester and 15 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 75 weight % of said at least one aliphatic-aromatic polyester and 25 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 70 weight % of said at least one aliphatic-aromatic polyester and 30 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 65 weight % of said at least one aliphatic-aromatic polyester and 35 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 55 weight % of said at least one aliphatic-aromatic polyester and 45 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 50 weight % of said at least one aliphatic-aromatic polyester and 50 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 45 weight % of said at least one aliphatic-aromatic polyester and 55 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 40 weight % of said at least one aliphatic-aromatic polyester and 60 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 35 weight % of said at least one aliphatic-aromatic polyester and 65 to 80 weight % of said at least one aliphatic polyester, wherein the total weight % of the aliphatic-aromatic polyester and the aliphatic polyester equals 100 weight %. In one embodiment, the polymer blends of the invention can comprise 20 to 30 weight % of said at least one aliphatic-aromatic polyester and 70 to 80 weight % of said at least one aliphatic polyester, wherein the total weight % of the aliphatic-aromatic polyester and the aliphatic polyester equals 100 weight %.

In one embodiment, the polymer blends of the invention can comprise 30 to 90 weight % of said at least one aliphatic-aromatic polyester and 10 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 85 weight % of said at least one aliphatic-aromatic polyester and 15 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 75 weight % of said at least one aliphatic-aromatic polyester and 25 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 70 weight % of said at least one aliphatic-aromatic polyester and 30 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 65 weight % of said at least one aliphatic-aromatic polyester and 35 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 55 weight % of said at least one aliphatic-aromatic polyester and 45 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 50 weight % of said at least one aliphatic-aromatic polyester and 50 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 45 weight % of said at least one aliphatic-aromatic polyester and 55 to 70 weight % of said at least one aliphatic polyester, wherein the total weight % of the aliphatic-aromatic polyester and the aliphatic polyester equals 100 weight %. In one embodiment, the polymer blends of the invention can comprise 30 to 40 weight % of said at least one aliphatic-aromatic polyester and 60 to 70 weight % of said at least one aliphatic polyester, wherein the total weight % of the aliphatic-aromatic polyester and the aliphatic polyester equals 100 weight %.

In one embodiment, the polymer blends of the invention can comprise 40 to 90 weight % of said at least one aliphatic-aromatic polyester and 10 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 85 weight % of said at least one aliphatic-aromatic polyester and 15 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 75 weight % of said at least one aliphatic-aromatic polyester and 25 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 70 weight % of said at least one aliphatic-aromatic polyester and 30 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 65 weight % of said at least one aliphatic-aromatic polyester and 35 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 55 weight % of said at least one aliphatic-aromatic polyester and 45 to 60 weight % of said at least one aliphatic polyester, wherein the total weight % of the aliphatic-aromatic polyester and the aliphatic polyester equals 100 weight %. In one embodiment, the polymer blends of the invention can comprise 40 to 50 weight % of said at least one aliphatic-aromatic polyester and 50 to 60 weight % of said at least one aliphatic polyester, wherein the total weight % of the aliphatic-aromatic polyester and the aliphatic polyester equals 100 weight %.

In one embodiment, the polymer blends of the invention can comprise 50 to 90 weight % of said at least one aliphatic-aromatic polyester and 10 to 50 weight % of said at least one aliphatic polyester, wherein the total weight % of the aliphatic-aromatic polyester and the aliphatic polyester equals 100 weight %. In one embodiment, the polymer blends of the invention can comprise 50 to 85 weight % of said at least one aliphatic-aromatic polyester and 15 to 50 weight % of said at least one aliphatic polyester, wherein the total weight % of the aliphatic-aromatic polyester and the aliphatic polyester equals 100 weight %. In one embodiment, the polymer blends of the invention can comprise 50 to 75 weight % of said at least one aliphatic-aromatic polyester and 25 to 50 weight % of said at least one aliphatic polyester, wherein the total weight % of the aliphatic-aromatic polyester and the aliphatic polyester equals 100 weight %. In one embodiment, the polymer blends of the invention can comprise 20 to 50 weight % of said at least one aliphatic-aromatic polyester and 30 to 50 weight % of said at least one aliphatic polyester, wherein the total weight % of the aliphatic-aromatic polyester and the aliphatic polyester equals 100 weight %. In one embodiment, the polymer blends of the invention can comprise 50 to 65 weight % of said at least one aliphatic-aromatic polyester and 35 to 50 weight % of said at least one aliphatic polyester, wherein the total weight % of the aliphatic-aromatic polyester and the aliphatic polyester equals 100 weight %.

In one embodiment, the polymer blends of the invention can comprise 10 to 50 weight % of said at least one aliphatic-aromatic polyester and 50 to 90 weight % of said at least one aliphatic polyester, wherein the total weight % of the aliphatic-aromatic polyester and the aliphatic polyester equals 100 weight %. In one embodiment, the polymer blends of the invention can comprise 20 to 50 weight % of said at least one aliphatic-aromatic polyester and 50 to 80 weight % of said at least one aliphatic polyester, wherein the total weight % of the aliphatic-aromatic polyester and the aliphatic polyester equals 100 weight %. In one embodiment, the polymer blends of the invention can comprise 40 to 60 weight % of said at least one aliphatic-aromatic polyester and 60 to 40 weight % of said at least one aliphatic polyester, wherein the total weight % of the aliphatic-aromatic polyester and the aliphatic polyester equals 100 weight %. In one embodiment, the polymer blends of the invention can comprise 45 to 55 weight % of said at least one aliphatic-aromatic polyester and 55 to 45 weight % of said at least one aliphatic polyester, wherein the total weight % of the aliphatic-aromatic polyester and the aliphatic polyester equals 100 weight %. In one embodiment, the polymer blends of the invention can comprise 50 weight % of said at least one aliphatic-aromatic polyester and 50 weight % of said at least one aliphatic polyester, wherein the total weight % of the aliphatic-aromatic polyester and the aliphatic polyester equals 100 weight %.

In one embodiment, the polymer blends of the invention comprise at least one aliphatic-aromatic polyester and at least one aliphatic polyester at a ratio or 9:1 within the total blend. In one embodiment, the polymer blends of the invention comprise at least one aliphatic-aromatic polyester and at least one aliphatic polyester at a ratio or 8:1 within the total blend. In one embodiment, the polymer blends of the invention comprise at least one aliphatic-aromatic polyester and at least one aliphatic polyester at a ratio or 7:1 within the total blend. In one embodiment, the polymer blends of the invention comprise at least one aliphatic-aromatic polyester and at least one aliphatic polyester at a ratio or 6:1 within the total blend. In one embodiment, the polymer blends of the invention comprise at least one aliphatic-aromatic polyester and at least one aliphatic polyester at a ratio or 5:1 within the total blend. In one embodiment, the polymer blends of the invention comprise at least one aliphatic-aromatic polyester and at least one aliphatic polyester at a ratio or 4:1 within the total blend. In one embodiment, the polymer blends of the invention comprise at least one aliphatic-aromatic polyester and at least one aliphatic polyester at a ratio or 3:1 within the total blend. In one embodiment, the polymer blends of the invention comprise at least one aliphatic-aromatic polyester and at least one aliphatic polyester at a ratio or 2:1 within the total blend. In one embodiment, the polymer blends of the invention comprise at least one aliphatic-aromatic polyester and at least one aliphatic polyester at a ratio or 1:1 within the total blend.

In one embodiment, the polymer blends of the invention comprise at least one aliphatic-aromatic polyester and at least one aliphatic polyester at a ratio or 1:9 within the total blend. In one embodiment, the polymer blends of the invention comprise at least one aliphatic-aromatic polyester and at least one aliphatic polyester at a ratio or 1:8 within the total blend. In one embodiment, the polymer blends of the invention comprise at least one aliphatic-aromatic polyester and at least one aliphatic polyester at a ratio or 1:7 within the total blend. In one embodiment, the polymer blends of the invention comprise at least one aliphatic-aromatic polyester and at least one aliphatic polyester at a ratio or 1:6 within the total blend. In one embodiment, the polymer blends of the invention comprise at least one aliphatic-aromatic polyester and at least one aliphatic polyester at a ratio or 1:5 within the total blend. In one embodiment, the polymer blends of the invention comprise at least one aliphatic-aromatic polyester and at least one aliphatic polyester at a ratio or 1:4 within the total blend. In one embodiment, the polymer blends of the invention comprise at least one aliphatic-aromatic polyester and at least one aliphatic polyester at a ratio or 1:3 within the total blend. In one embodiment, the polymer blends of the invention comprise at least one aliphatic-aromatic polyester and at least one aliphatic polyester at a ratio or 1:2 within the total blend. In one embodiment, the polymer blends of the invention comprise at least one aliphatic-aromatic polyester and at least one aliphatic polyester at a ratio or 1:1 within the total blend.

The invention further relates to a polymer blend comprising polyesters other than the AAPE polyesters and aliphatic polyesters as described as useful previously in the polymer blends of the invention. The blend comprises:
(a) from 5 to 95 weight % of at least one of the AAPE polyesters described herein; and
(b) from 5 to 95 weight % of at least one of the aliphatic polyesters described herein;
(c) from 5 to 95 weight % of at least one additional polymeric components not including the polyesters of (a) and (b);

wherein the total weight percent of all polymeric components in the polymer blends of the invention equals a total of 100 weight %.

Suitable examples of the additional polymeric components include, but are not limited to, nylon; polyesters different than those described herein; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the foregoing polymers.

All polymer blends (also intended to encompass the word “mixtures”) of the invention can be prepared by conventional processing techniques known in the art, such as melt blending or solution blending. The compositions of this invention are prepared by any conventional mixing methods. For example, in one embodiment, the blending method comprises mixing the aliphatic-aromatic and aliphatic polyester in powder or granular form in an extruder and extruding the mixture into strands, chopping the strands into pellets and molding the pellets into the desired article.

In addition, the polyester blends of the invention may also contain from 0.01 to 25% by weight of the overall composition common additives such as colorants, dyes, mold release agents, flame retardants, plasticizers, nucleating agents, stabilizers, including but not limited to, UV stabilizers, thermal stabilizers and/or reaction products thereof, fillers, and impact modifiers. Examples of typical commercially available impact modifiers well known in the art and useful in this invention include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition

Reinforcing materials may be useful in the polymer blends of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

The polyester portion of the polyester blends useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

Additional Aliphatic-Aromatic Polyester(s) Description

In other aspects of the invention, the Tg of certain aliphatic-aromatic (AAPE) polyesters useful in the polyester blends of the invention can be at least one of the following ranges: 120 to 200° C.; 120 to 190° C.; 120 to 180° C.; 120 to 170° C.; 120 to 160° C.; 120 to 155° C.; 120 to 150° C.; 120 to 145° C.; 120 to 140° C.; 120 to 138° C.; 120 to 135° C.; 120 to 130° C.; 125 to 200° C.; 125 to 190° C.; 125 to 180° C.; 125 to 170° C.; 125 to 165° C.; 125 to 160° C.; 125 to 155° C.; 125 to 150° C.; 125 to 145° C.; 125 to 140° C.; 125 to 138° C.; 125 to 135° C.; 127 to 200° C.; 127 to 190° C.; 127 to 180° C.; 127 to 170° C.; 127 to 160° C.; 127 to 150° C.; 127 to 145° C.; 127 to 140° C.; 127 to 138° C.; 127 to 135° C.; 130 to 200° C.; 130 to 190° C.; 130 to 180° C.; 130 to 170° C.; 130 to 160° C.; 130 to 155° C.; 130 to 150° C.; 130 to 145° C.; 130 to 140° C.; 130 to 138° C.; 130 to 135° C.; 135 to 200° C.; 135 to 190° C.; 135 to 180° C.; 135 to 170° C.; 135 to 160° C.; 135 to 155° C.; 135 to 150° C.; 135 to 145° C.; 135 to 140° C.; 140 to 200° C.; 140 to 190° C.; 140 to 180° C.; 140 to 170° C.; 140 to 160° C.; 140 to 155° C.; 140 to 150° C.; 140 to 145° C.; 148 to 200° C.; 148 to 190° C.; 148 to 180° C.; 148 to 170° C.; 148 to 160° C.; 148 to 155° C.; 148 to 150° C.; greater than 148 to 200° C.; greater than 148 to 190° C.; greater than 148 to 180° C.; greater than 148 to 170° C.; greater than 148 to 160° C.; greater than 148 to 155° C.; 150 to 200° C.; 150 to 190° C.; 150 to 180° C.; 150 to 170° C.; 150 to 160; 155 to 190° C.; 155 to 180° C.; 155 to 170° C.; and 155 to 165° C.

In other aspects of the invention, the composition of certain AAPE polyesters useful in the polyester compositions of the invention can be at least one of the following Tg ranges: 120 to 190° C.; 130 to 190° C.; 160 to 190° C.; 165 to 190° C.

In other aspects of the invention, the glycol component for the AAPE polyesters useful in the polymer blends of the invention include but are not limited to at least one of the following combinations of ranges: 1 to less than 25 mole % diol other than 2,2,4,4-tetramethyl-1,3-cyclobutanediol; 75 to 100 mole % 2,2,4,4-tetramethyl-1,3-cyclobutanediol and 0 to 15 mole % diol other than 2,2,4,4-tetramethyl-1,3-cyclobutanediol; 90 to 100 mole % 2,2,4,4-tetramethyl-1,3-cyclobutanediol and 0 to 10 mole % diol other than 2,2,4,4-tetramethyl-1,3-cyclobutanediol.

In other aspects of the invention, the glycol component for the AAPE polyesters useful in the polymer blends of the invention include but are not limited to at least one of the following combinations of ranges: 90 to 100 mole 2,2,4,4-tetramethyl-1,3-cyclobutanediol and 0 to 90 mole cyclohexanedimethanol or other diol; greater than 90 to 99 mole % 2,2,4,4-tetramethyl-1,3-cyclobutanediol and 1 to less than 10 mole %.

In other aspects of the invention, the glycol component for the polyesters useful in the polymer blends of the invention include but are not limited to at least one of the following combinations of ranges: 75 to 99 mole % 2,2,4,4-tetramethyl-1,3-cyclobutanediol and 1 to 25 mole % cyclohexanedimethanol; 75 to 95 mole % 2,2,4,4-tetramethyl-1,3-cyclobutanediol and 5 to 25 mole % cyclohexanedimethanol; 75 to 90 mole % 2,2,4,4-tetramethyl-1,3-cyclobutanediol and 10 to 25 mole % cyclohexanedimethanol; 75 to 85 mole % 2,2,4,4-tetramethyl-1,3-cyclobutanediol and 15 to 25 mole % cyclohexanedimethanol; 75 to 80 mole % 2,2,4,4-tetramethyl-1,3-cyclobutanediol and 20 to 25 mole % cyclohexanedimethanol; 75 to 80 mole % 2,2,4,4-tetramethyl-1,3-cyclobutanediol and 20 to 25 mole % cyclohexanedimethanol.

In other aspects of the invention, the glycol component for the AAPE polyesters useful in the polymer blends of the invention include but are not limited to at least one of the following combinations of ranges: 80 to 99 mole % 2,2,4,4-tetramethyl-1,3-cyclobutanediol and 1 to 20 mole % cyclohexanedimethanol or other diol; 80 to 95 mole % 2,2,4,4-tetramethyl-1,3-cyclobutanediol and 5 to 20 mole % cyclohexanedimethanol or other diol; 80 to 90 mole % 2,2,4,4-tetramethyl-1,3-cyclobutanediol and 10 to 20 mole % cyclohexanedimethanol or other diol.

In other aspects of the invention, the glycol component for the AAPE polyesters useful in the invention include but are not limited to at least one a combinations of ranges of % 2,2,4,4-tetramethyl-1,3-cyclobutanediol, cyclohexanedimethanol and % ethylene glycol.

In certain embodiments, terephthalic acid or an ester thereof, such as, for example, dimethyl terephthalate or a mixture of terephthalic acid residues and an ester thereof can make up a portion or all of the dicarboxylic acid component used to form the polyesters useful in the invention. In certain embodiments, terephthalic acid residues can make up a portion or all of the dicarboxylic acid component used to form the polyesters useful in the invention. In certain embodiments, higher amounts of terephthalic acid can be used in order to produce a higher impact strength polyester. For purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the polyer blends of the invention. In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, the dicarboxylic acid component of the AAPE polyesters useful in the polymer blends of the invention can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-,1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the AAPE polyesters useful in the polymer blends of the invention can be further modified with up to 10 mole %, such as up to 5 mole % or up to 1 mole % of one or more aliphatic dicarboxylic acids containing 2-16 carbon atoms, such as, for example, cyclohexanedicarboxylic, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the invention.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The AAPE polyesters useful in the polymer blends of the invention can be amorphous or semicrystalline. In one aspect, certain AAPE polyesters useful in the invention can have relatively low crystallinity. Certain AAPE polyesters useful in the invention can thus have a substantially amorphous morphology, meaning that the AAPE polyesters comprise substantially unordered regions of polymer.

The AAPE polyesters useful in the invention in general may be prepared by condensing the dicarboxylic acid or dicarboxylic acid ester with the glycol in the presence of the tin catalyst described herein at elevated temperatures increased gradually during the course of the condensation up to a temperature of about 225° -310° C., in an inert atmosphere, and conducting the condensation at low pressure during the latter part of the condensation, as described in further detail in U.S. Pat. No. 2, 720, 507 incorporated herein by reference.

Additional Aliphatic Polyester Description

In one embodiment, cyclohexanedicarboxylic acid residues make up part or the entire dicarboxylic acid component used to make the aliphatic polyesters useful in the present invention. In certain embodiments, ranges of from 70 to 100 mole %; or 80 to 100 mole %; or 90 to 100 mole %; or 99 to 100 mole %; or 100 mole % cyclohexanedicarboxylic acid residues and/or esters thereof and/or mixtures thereof may be used.

In one embodiment, 1,4-cyclohexanedicarboxylic acid esters make up part or all of the dicarboxylic acid component used to make the aliphatic polyesters useful in the present invention. In certain embodiments, ranges of from 70 to 100 mole %; or 80 to 100 mole %; or 90 to 100 mole %; or 99 to 100 mole %; or 100 mole % 1,4-cyclohexanedicarboxylic acid esters may be used.

In one embodiment, dimethyl-1,4-cyclohexanedicarboxylate (DMCD) makes up part or all of the dicarboxylic acid component used to make the aliphatic polyesters useful in the present invention. In certain embodiments, ranges of from 70 to 100 mole %; or 80 to 100 mole %; or 90 to 100 mole %; or 99 to 100 mole %; or 100 mole % dimethyl-1,4-cyclohexanedicarboxylate may be used.

As used herein, the term “cyclohexanedicarboxylic acid” is intended to include cyclohexanedicarboxylic acid itself and residues thereof as well as any derivative or isomer of cyclohexanedicarboxylic acid, including its associated esters, half-esters, salts, half-salts and/or mixtures thereof or equivalents thereof. Any of 1,1-, 1,2-, 1,3-, 1,4- isomers of cyclohexanedicarboxylic acids or esters thereof or mixtures thereof may be present in the aliphatic acid component of this invention. Cis and trans isomers do not exist for 1,1-cyclohexanedicarboxylic acid.

In other aspects of the invention, the Tg of the aliphatic polyesters useful in the polyester compositions of the invention can be at least one of the following ranges: 50 to 100° C.; 50 to 95° C.; 50 to 90° C.; 50 to 85° C.; 50 to 80° C.; 50 to 75° C.; 50 to 70° C.; 50 to 65° C.; 55 to 100° C.; 55 to 95° C.; 55 to 90° C.; 55 to 85° C.; 55 to 80° C.; 55 to 75° C.; 55 to 70° C.; 55 to 65° C.; 60 to 100° C.; 60 to 95° C.; 60 to 90° C.; 60 to 85° C.; 60 to 80° C.; 60 to 75° C.; 60 to 70° C.; 60 to 65° C.; 65 to 100° C.; 65 to 95° C.; 65 to 90° C.; 65 to 85° C.; 65 to 80° C.; 65 to 75° C.; 65 to 70° C.; 70 to 100° C.; 70 to 95° C.; 70 to 90° C.; 70 to 85° C.; 70 to 80° C.; 70 to 75° C.; 75 to 100° C.; 75 to 95° C.; 75 to 90° C.; 75 to 85° C.; 75 to 80° C.; 80 to 100° C.; 80 to 95° C.; 80 to 90° C.; 80 to 85° C.; 85 to 100° C.; 85 to 95° C.; 85 to 90° C.; 90 to 100° C.; 90 to 95° C.; and 95 to 100° C.

In other aspects of the invention, the composition of certain aliphatic polyesters useful in the polyester compositions of the invention can be at least one of the following Tg ranges: 60 to 155° C.; and 110 to 140° C.

In addition to cyclohexanedicarboxylic acid, the dicarboxylic acid component of the polyesters useful in the invention can comprise up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, terephthalic acid, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid. In one embodiment, the modifying aromatic dicarboxylic acid is terephthalic acid.

As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

In certain embodiments, terephthalic acid or an ester thereof, such as, for example, dimethyl terephthalate or a mixture of terephthalic acid residues and an ester thereof can make up a portion or all of the aromatic dicarboxylic acid component, if any, used to form the polyesters useful in the invention. In certain embodiments, terephthalic acid residues can make up a portion or all of the aromatic dicarboxylic acid component, if any, used to form the polyesters useful in the invention. For purposes of this disclosure, the terms “terephthalic acid” and “dimethyl terephthalate” are used interchangeably herein. In one embodiment, dimethyl terephthalate is part or all of the aromatic dicarboxylic acid component, if any, used to make the polyesters useful in the present invention.

The carboxylic acid component of the polyesters useful in the invention can be further modified with up to 30 mole %, such as up to 25 mole % or such as up to 20 mole % such as up to15 mole % or such as up to 10 mole % or such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is equal to 100 mole %. In one embodiment, adipic acid and/or glutaric acid are provided in the modifying aliphatic dicarboxylic acid component of the invention.

Esters of dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and In one embodiment, the glycol component of the polyester portion of the polyester compositions useful in the invention can contain in addition to 2,2,4,4-tetramethyl-1,3-cyclobutanediol or; 20 mole % or less of one or more modifying glycols which are not; in one embodiment, the polyesters useful in the invention may contain less than 15 mole % or of one or more modifying glycols. In another embodiment, the polyesters useful in the invention can contain 10 mole % or less of one or more modifying glycols. In another embodiment, the polyesters useful in the invention can contain 5 mole % or less of one or more modifying glycols. In another embodiment, the polyesters useful in the invention can contain 3 mole % or less of one or more modifying glycols. In another embodiment, the polyesters useful in the invention can contain 2 mole % or less of one or more modifying glycols. In another embodiment, the polyesters useful in the invention can contain 0 mole % modifying glycols.

### Articles of the Invention

In one embodiment, this invention includes articles of manufacture comprising any of the polyester blends of the invention.

The invention further relates to the film(s) and/or sheet(s) comprising the polyester blends. The methods of forming the polyesters into film(s) and/or sheet(s) are well known in the art. Examples of film(s) and/or sheet(s) of the invention including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting. In one embodiment, this invention includes articles of manufacture comprising the polyester blends of the invention.

In one embodiment, this invention includes articles of manufacture comprising any of the polyester blends of the invention which is extrusion molded.

In one embodiment, this invention includes articles of manufacture comprising any of the polyester blends of the invention which is extrusion stretch blow molded.

In one embodiment, this invention includes articles of manufacture comprising any of the polyester blends of the invention which is injection molded.

In one embodiment, this invention includes articles of manufacture comprising the polyester blends of the invention which is injection blow molded.

In one embodiment, this invention includes articles of manufacture comprising the polyester blends of the invention which is injection stretch blow molded.

In one embodiment, the articles of manufacture included in this invention are visually clear comprising any of the polyester blends of the invention.

### EXAMPLES

The invention is further illustrated by the following examples. Inherent viscosities (IV) were measured in 60/40 (wt/wt) phenol/tetrachloroethane at a concentration of 0.25 g/50 ml at 25° C. according to standard methods that are described in ASTM Method D4603. The inherent viscosity of the polyesters was determined in 60/40 (wt/wt) phenol/tetrachloroethane at a concentration of 0.5 g/100m1 at 25° C. The glass transition temperatures were determined using a Perkin Elmer differential scanning calorimeter (DSC) at a scan rate of 20° C. The composition of the neat resins was determined by proton nuclear magnetic resonance spectroscopy (NMR). The miscibility of the blends was determined by the presence of a single glass transition and clarity compounded blend, in the melt phase or the solid phase. As referred to herein, PTTMCD is a polyester comprising units of terephthalic acid and at least 90 mol % 2,2,4,4-tetramethy-1,3-cyclobutanediol with at most 10 mol % of a second glycol.

Polyester PTTMCD was prepared from terephthalic acid and 2,2,4,4-tetramethy-1,3-cyclobutanediol (TMCD). The final composition had 4 mol % ethylene glycol (EG) because some catalyst is delivered in an EG solution. Synthesis was carried out in an 18-gallon stainless steel reactor which is fitted with twin intermeshing spiral agitators and a heated reflux column. To the 18-gallon reactor under a 10 SCFH nitrogen purge 49.71 gram-moles of DMT, 59.65 gram-moles of TMCD. Also, 4.98 gram-moles of EG were charged as catalyst solution, sufficient dibutyltin oxide was charged to the reaction mixture to provide 200 ppm tin. While under a 10 SCFH nitrogen purge and agitating at 25 RPM in forward (pumping down) direction, the reaction mixture was set to heat to 200° C. When the reaction mixture was 150° C., the nitrogen purge was turned off and the reactor was pressurized to 25 psig with nitrogen. When the reaction mixture was 200° C. and under 25 psig pressure, it was held for 30 minutes. After the 30 minute hold period at 200° C. and 25 psig, the pressure was reduced to 7 psig and the reaction mixture was heated to 236° C. where it was held for 30 minutes. After the 30 minute hold period at 236° C. and 7 psig, the pressure was reduced to 0 psig and the reaction mixture was heated to 248° C. where it was held for 30 minutes. After the 30 minute hold period at 248° C. and 0 psig, the pressure was reduced to 375-mm and the reaction mixture was heated to 255° C. where it was held for 60 minutes with the agitation speed reduced to 15 RPM in reverse (lifting) direction. After the 60 minute hold period at 255° C. and 375-mm, the pressure was reduced to 20-mm and the reaction mixture was heated to 260° C. where it was held for 40 minutes. After the 40 minute hold period at 260° C. and 20-mm, at the same time the pressure was ramped to full vacuum (<0.5-mm) and the reaction mixture temperature was ramped to 280° C. When the reaction mixture was 280° C. and <2-mm, it was held for 1 hour while agitating at 15 RPM in reverse (lifting) direction. After the 1 hour hold period at 280° C. and <0.5-mm, the reaction mixture was heated to 300° C. where it was held for 2 hours. After the 2 hour hold period at 300° C. and <0.5-mm, the agitator was switched to forward (pumping down) direction and the reaction mixture was held for 10 minutes at 300° C. and <0.5-mm. After the 10 minute hold time at 300° C. and <0.5-mm while agitating at 15 RPM in forward (pumping down) direction, the pressure was increased to 0 psig with nitrogen and the resulting polymer under a 10 SCFH nitrogen purge was extruded into cold water. The cooled, extruded polymer was ground to pass a 6-mm screen.

The resulting polymer had an inherent viscosity value of 0.477. By NMR analysis the polymer contained 1.6 mol % ethylene glycol moiety. The polymer had a “L* color” value of 76.11, an “a* color value” of −1.08 and a “b* color” value of 18.89.

Also used are two commercially available copolyesters, PCCD (Neostar^{TM} 19972 Copolyester) and PCT (Eastman™ 13787 Polyester). Polyesters used to make the blends of this invention are shown in Table 1 below.

### Example 1

### Of the Invention

The aliphatic-aromatic copolyester used contained terephthalic acid, 96 mole % 2,2,4,4, tetramethyl-1,3 cyclobutanediol, and 4 mole % ethylene glycol (PTTMCD). The inherent viscosity was measured to be 0.477. The above paragraphs describe the details of the synthesis.

The aliphatic-aromatic copolyester was dried at 90° C. and the aliphatic polyester PCCD was dried at 70° C. Blends were prepared in a 19 mm APV twin screw extruder. The polyesters were premixed by tumble blending and fed into the extruder and the extruded strand was either quenched in cold water or collected on a solid surface and set aside to slowly cool. Processing set temperatures used were in the range of 250° C. to 280° C. The blend was clear when quenched or slow cooled and is miscible. The compositions and properties of the blends are shown in Table 1.

### Example 2

### Comparative Example

The same aliphatic-aromatic copolyester used in Example 1 was dried at 90° C. and a commercially available polyester of terephthalic acid and 1,4 cyclohexanedimethanol PCT was dried at 110° C. Its inherent viscosity was 0.77. Blends were prepared in a 19 mm APV twin screw extruder. The polyesters were premixed by tumble blending and fed into the extruder and the extruded strand was either quenched in cold water or collected on a solid surface and set aside to slowly cool. Processing set temperatures used were in the range of 250° C. to 280° C. The compositions and properties of the blends are shown in Table 1. The blend was hazy when quenched and slow cooled and is immiscible

### Example 3

### Comparative Example

The aliphatic-aromatic copolyester PCT from example 2 was dried at 110° C. and the aliphatic polyester PCCD of Example 1 was dried at 70° C. Blends were prepared in a 19mm APV twin screw extruder. The polyesters were premixed by tumble blending and fed into the extruder and the extruded strand was either quenched in cold water or collected on a solid surface and set aside to slowly cool. Processing set temperatures used were in the range of 250° C. to 280° C. The compositions and properties of the blends are shown in Table

TABLE 1

| | | Neat resin | | | EXAMPLE | COMPARATIVE | COMPARATIVE |
|---|---|---|---|---|---|---|---|
| | UNITS | Properties | | | 1 | EXAMPLE 2 | EXAMPLE 3 |
| Weight % | % | 100 | 0 | 0 | 50 | 50 | 0 |
| PTTMCD | | | | | | | |
| Weight % | % | 0 | 100 | 0 | 50 | 0 | 25 |
| PCCD | | | | | | | |
| Weight % PCT | % | 0 | 0 | 100 | 0 | 50 | 75 |
| DSC Tg | | 192 | | 91 | 114 | No identifiable transitions due to | |
| (First Cycle) | | | | | | noise and crystallization. | |
| DSC Tg | ° C. | 189 | 60 | 89 | 109 | | |
| (Second Cycle) | | | | | | | |
| Visual Clarity | | Clear | Clear | Clear | Clear | Hazy | Hazy |

The invention has been described in detail with reference to the embodiments disclosed herein, but it will be understood that variations and modifications can be effected within the spirit and scope of the invention.

We claim:

1. A polymer blend comprising:
(A) 5 to 95 weight % of at least one aliphatic-aromatic copolyester which comprises:
(i) a dicarboxylic acid component comprising:
(a) 70 to 100 mole % of terephthalic acid residues; and
(b) 0 to 30 mole % of one or more dicarboxylic acid residues; and,
(ii) a glycol component comprising:
(a) 75 to 100 mole % of 2,2,4,4-tetramethyl-1,3-cyclobutanediol residues; and,
(b) 0 to 25 mole % of one or more additional glycol residues;
wherein the total mole % of the dicarboxylic acid component is 100 mole % and wherein the total mole % of the glycol component is 100 mole %;
and,
(B) 5 to 95 weight % of at least one aliphatic polyester which comprises:
(i) a dicarboxylic acid component comprising cyclohexanedicarboxylic acid residues; and,
(ii) a glycol component comprising:
(a) 75 to 100 mole % cyclohexanedimethanol residues; and,
(b) 0 to 25 mole % of one or more additional glycol or polymeric glycol residues; and,
(c) 0 to 5 mole % of one or more branching agents;
wherein the total mole % of the dicarboxylic acid component is 100 mole % and wherein the total mole % of the glycol component is 100 mole % and wherein the weight percentages are based on the total weight of the polymer blend.
